(19) United States
(12) Patent Application Publication
(10) Pub. No.: US 2007/0145884 A1
(43) Pub. Date: Jun. 28, 2007

(54) Light emitting diode die with at least one phosphor layer and method for forming the same

(75) Inventors: Enboa Wu, Irvine, CA (US); Tun-Yen Kan, Taipei (TW)

Correspondence Address: MERCHANT & GOULD PC, P.O. BOX 2903, MINNEAPOLIS, MN, 55402-0903, US

(73) Assignee: Hong Kong Applied Science and Technology Research Institute Company Limited, Shatin, NT (CN)

(21) Appl. No.: 11/509,509

(22) Filed: Aug. 22, 2006

(30) Foreign Application Priority Data
Dec. 23, 2005 (CN) 200510132416.X

(51) Int. Cl. H01J 1/62; H01J 63/04

(52) U.S. Cl. 313/503; 313/512

(57) ABSTRACT

The present application discloses a light emitting diode die with at least one phosphor layer, comprising a substrate having a first surface and a second surface opposing to the first surface; a light-emitting structure being formed on the first surface and emitting a primary light with a specific wavelength while being driven by a voltage wherein the primary light is capable of passing through the substrate; and, at least one phosphor layer with plate-shaped structure formed on the second surface, wherein at least one phosphor layer comprises at least one type of organic material and at least one type of phosphor substance that absorbs and converts part of the primary light to thereby emit at least a secondary light with a different wavelength from the specific wavelength. In addition, the present invention discloses methods for forming a light emitting diode die with at least one phosphor layer.

### BACKGROUND OF THE INVENTION

1. Field of the Invention

The present invention is generally related to a light emitting diode die, and more particularly to a light emitting diode die with a plate shaped phosphor layer and a method for forming the same.

2. Description of the Prior Art

Light emitting diode recently has been viewed as a new generation of lighting equipments because of its excellent characteristics, such as long lifetime, a low current usage, no heat radiation, and mercury-free.

The U.S. Pat. No. 6,614,179 discloses a white light emitting diode structure with a yellow YAG phosphor substance, which is wire-bonding packaged by mixing phosphor substance into an epoxy resin or urea resin and filling such resin having the phosphor substance into the exterior cup space of the light emitting diode. The above-mentioned structure has two major disadvantages: (1) the difficulty in dissipating the heat produced by the device, which thereby shortens the lifetime of the die; (2) the volume of the resin being too big to block outgoing light by part of the phosphor substance, which thereby results in lowering the whole light attaining efficiency and design difficulty of the light conversion ratio of each color. In light of the above-mentioned matter, it is required to develop a novel packaging method and phosphor dispersion method to reduce manufacturing cost and increase the lifetime of the device.

### SUMMARY OF THE INVENTION

According to the above, the present invention provides a new light emitting diode die with at least one phosphor layer and a method for forming the same to fulfill the requirements of this industry.

One object of the present invention is to complete the phosphor packaging operation directly under a wafer level so as to reduce the manufacturing cost. The process according to the present invention is applicable to the diodes emitting visible and the diodes emitting non-visible light as well. In addition, according to the present invention, phosphor substance can be dispersed into organic material to form an intermediate solution and thereby the intermediate solution is deposited onto a wafer by a coating, printing, screen printing, spraying, impressing and injet printing. Thus, such process is in a simple manner and easy to practice.

Another object of the present invention is to disperse phosphor substance unevenly in the phosphor layer to have the dispersion density of the phosphor substance increases along at least a specific direction that parallels the direction of the phosphor layer.

Another object of the present invention is to adjust the refractive index of each layer of the phosphor layers to have a structure with gradually changed refractive index so as to reduce the reflections of the primary light and the secondary light in the phosphor layers, which thereby increases the whole light attaining efficiency. According to the above, the present invention does have the economic advantages for industrial applications.

According to above-mentioned objectives, the present invention discloses a light emitting diode die with at least one phosphor layer, comprising a substrate having a first surface and a second surface, a light-emitting structure formed on the first surface, and at least one phosphor layer formed on the second surface. While driven by a voltage, the light-emitting structure emits a primary light with a specific wavelength wherein the primary light is capable of transmitting through the substrate. Besides, the phosphor layer comprises at least one type of organic material and at least one type of phosphor substance that absorbs and converts part of the primary light to thereby emit at least a secondary light with a different wavelength from the specific wavelength. In addition, the present invention discloses methods for forming a light emitting diode die with at least one phosphor layer.

### BRIEF DESCRIPTION OF THE DRAWINGS

FIG. 1A shows the schematic structure of a light emitting diode die having a phosphor layer according to the first embodiment of the present invention;

FIG. 1B shows the schematic structure of phosphor substance unevenly dispersed in the phosphor layer according to the first embodiment of the present invention;

FIG. 1C shows the schematic structure of phosphor substance unevenly dispersed in the phosphor layer according to the first embodiment of the present invention;

FIG. 1D shows the schematic structure of phosphor substance unevenly dispersed in the phosphor layer according to the first embodiment of the present invention;

FIG. 1E shows the schematic structure of phosphor substance unevenly dispersed in the phosphor layer according to the first embodiment of the present invention;

FIG. 1F shows the schematic structure of a light emitting diode die having a protection layer according to the first embodiment of the present invention;

FIG. 1G shows the schematic structure of a light emitting diode die having a ultraviolet light blocking layer according to the first embodiment of the present invention;

FIG. 1H shows the schematic structure of a light emitting diode die having two phosphor layers with different refractive indexes according to the first embodiment of the present invention;

FIG. 2 shows the schematic structure of a light emitting diode die having a plurality of phosphor layers according to the second embodiment of the present invention;

FIG. 2 shows the flow chart for manufacturing a light emitting diode die with at least one phosphor layer according to the second embodiment of the present invention;

FIG. 3A shows the flow chart for manufacturing a light emitting diode die with at least one phosphor layer according to the third embodiment of the present invention;

FIG. 3B shows the flow chart for unevenly dispersing phosphor substance in the phosphor layer according to the third embodiment of the present invention;

FIG. 3C shows the flow chart for unevenly dispersing phosphor substance in the phosphor layer according to the third embodiment of the present invention;

FIG. 3D shows the flow chart for unevenly dispersing phosphor substance in the phosphor layer according to the third embodiment of the present invention;

FIG. 4 shows the flow chart for manufacturing a light emitting diode die with at least one phosphor layer according to the fourth embodiment of the present invention.

### DESCRIPTION OF THE PREFERRED EMBODIMENTS

What is probed into the invention is a light emitting diode die with at least one phosphor layer and a method for forming the same. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

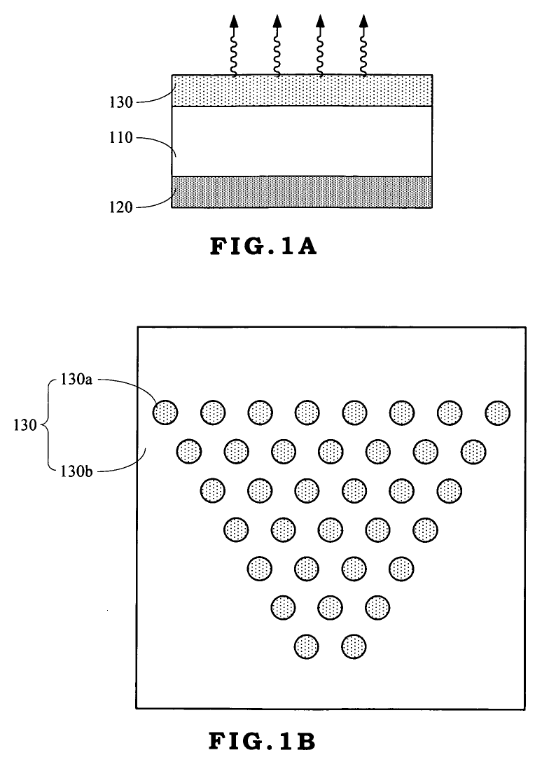

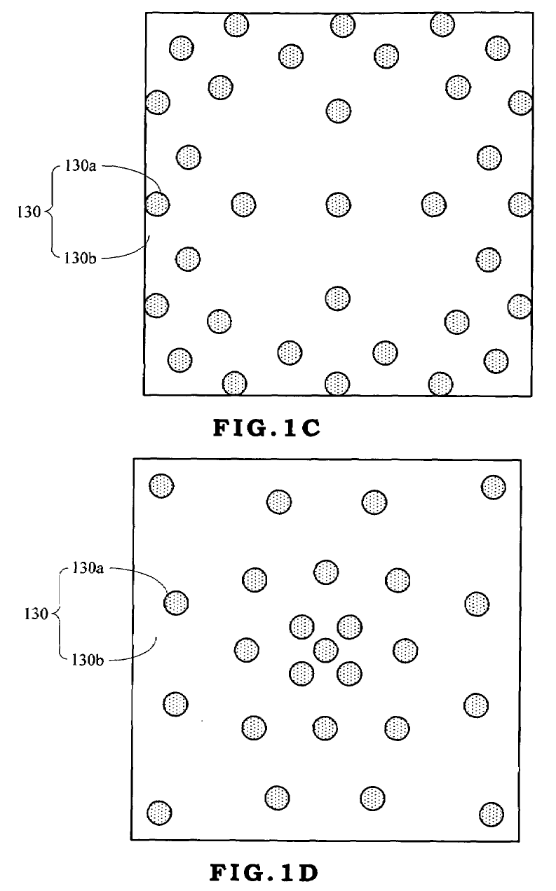

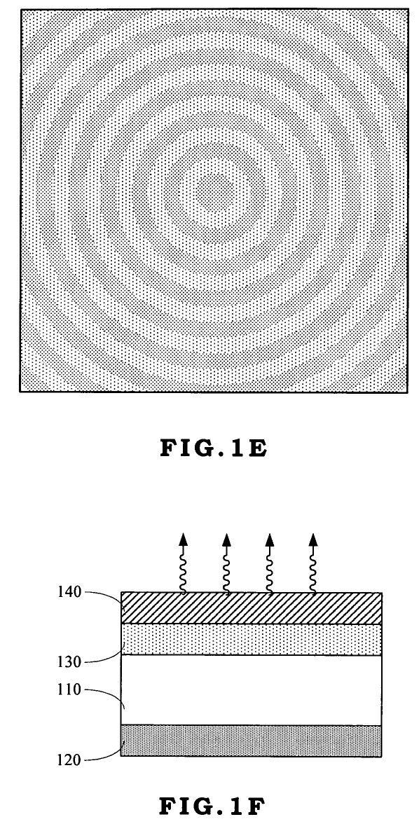

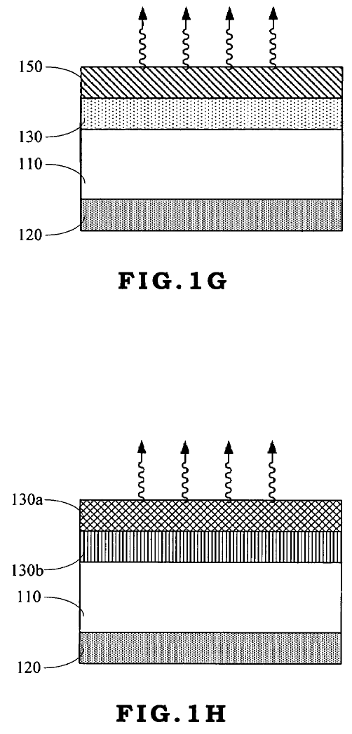

Referring to FIG. 1A, the first embodiment of the present invention discloses a light emitting diode die with at least one phosphor layer, comprising a substrate 110 having a first surface and a second surface; a light-emitting structure 120 formed on the first surface; and, at least one phosphor layer 130 with plate-shaped structure formed on the second surface. While driven by a voltage, the light-emitting structure 120 thereby emits a primary light (e.g. blue light) with a specific wavelength in which the primary light is capable of transmitting through the substrate. Besides, the phosphor layer 130 comprises at least one type of organic material and at least one type of phosphor substance that dispersed uniformly in the organic material. The phosphor substance absorbs and converts part of the primary light to thereby emit at least a secondary light with a different wavelength from the specific wavelength. Furthermore, the light-emitting structure 120 comprises a plurality of semiconductor layers. For example, a blue-ray light-emitting structure comprises: n-GaN layers, SQW or MQW GaInN layer, p-AlGaN layer and p-GaN layer. Additionally, the light-emitting structure 120 can further comprise n-electrode bond pad, n-electrode, p-electrode bond pad and p-electrode.

In this embodiment, the thickness of the phosphor layer 130 is equal to or greater than 20 nm. The preferred thickness is equal to or greater than 1 μm (which is called “thick film phosphor layer”), and more preferred, the thickness is equal to or greater than 10 μm. The preferred shape of the phosphor substance is in the form of particles. The particle diameter is equal to or greater than 10 nm. Furthermore, the organic material comprises one of the following group: molecules, oligomers, and polymers. The preferred organic material is selected to have the properties of high transparency, low moisture-absorbance, and high heat stability. When the organic material is polymer, a preferred option is that the glass transition temperature of the polymer is equal to or more than 150° C. Another preferred option is that the polymer comprises one of the following group: epoxy, polyether-polysulfone (PES), polyarylene sulfide (PAS), polybenzimidazoles (PBI), polyacrylate, polyamide (PA), polyimide (PI), polyether-polyimide (PEI), polyarylate (PAR), cyclic olefin copolymer (COC), polycarbonate (PC), and their copolymers.

In this embodiment, the phosphor layer 130 is formed by a method selected from a group consisting of coating, printing, screen printing, spraying, impressing and injet printing. Additionally, the coating method further comprises one of the following group: spin coating, wire-bar coating, blade coating, roller coating, dip coating . . . etc.

In this embodiment, when the phosphor substance is in the form of particles, the phosphor particles can be unevenly dispersed in the phosphor layer, such as the following four dispersion cases (Referring to FIGS. 1B to 1E, 130a represents the phosphor particles and 130b represents the organic material.). (1) The dispersion density of the phosphor particles 130a increases along a specific direction that parallels the direction of the phosphor layer 130. (2) The dispersion density of the phosphor particles 130a increases along a radial direction from the center of the phosphor layer 130, as viewed from top of the phosphor layer 130. (3) The dispersion density of the phosphor particles 130a decreases along a radial direction from the center of the phosphor layer 130, as viewed from top of the phosphor layer 130. (4) The dispersion density of the phosphor particles 130a has an undulating distribution radially spreading out from the center of the phosphor layer130, as viewed from top of the phosphor layer 130. On the other hand, as shown in FIG. 1F, the light emitting diode die with at least one phosphor layer further comprises a protection layer 140 formed on the phosphor layer 130 to prevent the phosphor layer 130 from moisture, acid, and base exposure or external force impact so as to increase the lifetime of the phosphor substance. Furthermore, the thermal stress, generated while utilizing the light emitting diode die according to the present invention, can be released by the protection layer 140.

In a preferred example of this embodiment, a tertiary light (e.g. white light) is generated by mixing the unabsorbed primary light that transmits through the substrate 110 with the at least one secondary light. In another preferred embodiment of the first embodiment, the primary light is ultraviolet and the phosphor substance includes red, green, and blue phosphors. While the primary light transmits through the substrate 110 to reach the phosphor layer 130, the red, green, and blue phosphors absorb and convert part of the ultraviolet light to emit red, green, and blue lights, respectively. Mixing the emitted red, green, and blue lights generates white lights. In addition, as shown in FIG. 1G, the light emitting diode die with at least one phosphor layer further comprises an ultraviolet light blocking layer 150 located on the surface of the phosphor layer, which is on the far side from the substrate. The ultraviolet light blocking layer 150 absorbs or reflects the ultraviolet light that is not absorbed by the at least one type of phosphor substance to prevent the ultraviolet light from being outbound. The ultraviolet light blocking layer 150 can be provided by the following four ways. (1) The ultraviolet light blocking layer is consisted of an encapsulant and an ultraviolet light blocking material dispersed in the encapsulant wherein the encapsulant is silicone. (2) The ultraviolet light blocking layer includes moisture-resistant, acid-base resistant, and wear-resistant materials. (3) The ultraviolet light blocking layer comprises a secondary multilayer structure (e.g. Bragg reflector). (4) The protection layer is located on the surface of the ultraviolet light blocking layer, which is on the far side from the substrate. The ultraviolet light blocking layer 150 allows transitions of visible light. Therefore, the ultraviolet light blocking layer 150 does not affect the light attaining efficiency of the light emitting diode die. It also ensures that users will not be exposed to ultraviolet light to increase the safety of the product. Besides, the light emitting diode die with at least one phosphor layer is connected to other devices in a flip chip state.

In this embodiment, when the mentioned light emitting diode die with a plurality of phosphor layers, the refractive index of each phosphor layer of said phosphor layers decreases with the increase of the distance between each phosphor layer and said light-emitting structure. Referring to FIG. 1H, in another preferred example of this embodiment, the phosphor layers comprise two layers 130a and 130b. The refractive indexes of the phosphor layer 130a and the phosphor layer 130b are both between the refractive index of the substrate 110 and the refractive index of air. The phosphor layer 130b is farther from the light-emitting structure 120 than the phosphor layer 130a is. Therefore, the refractive index of the phosphor layer 130b is smaller than that of the phosphor layer 130a. The design of using a structure with gradually changed refractive index utilizes Fresnel reflection principle to effectively reduce the reflections of the primary light an the secondary light in the phosphor layers so as to increase the whole light attaining efficiency of the light emitting diode die.

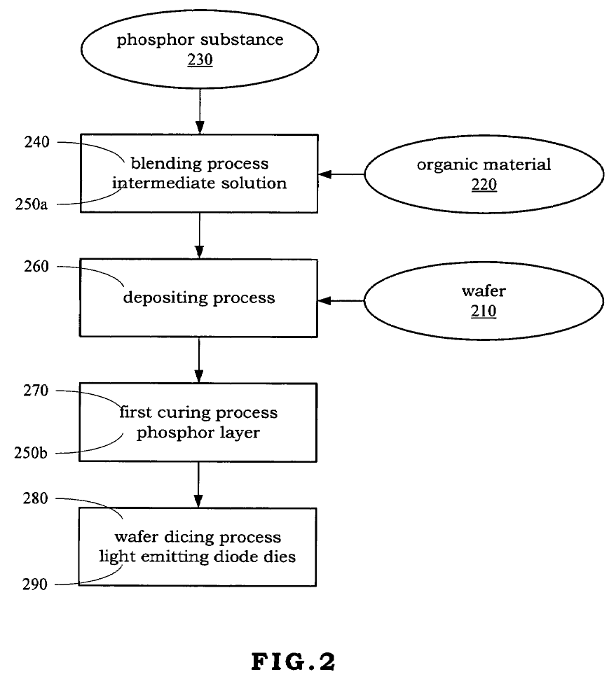

As shown in FIG. 2, the second embodiment of the invention discloses a method for forming a light emitting diode die with at least one phosphor layer. At first, a wafer 210 having a first surface and a second surface opposing to said first surface is provided, and a light-emitting structure is then formed on said first surface of said wafer. The mentioned wafer includes a single crystal wafer. The material of the wafer is selected from a group consisting of the following: silicon carbide and sapphire. Next, a blending process 240 is performed to blend at least one type of phosphor substance 230 with at least one type of organic material 220 to disperse the phosphor substance 230 into the organic material 220 so as to form an intermediate solution 250a. The amount of the phosphor substance 230 added is equal to or greater than the 20% weight of the organic material 220. The selection of the organic material is described in the first embodiment. Subsequently, a depositing process 260 is performed to deposit the intermediate solution 250a onto the second surface of the wafer. Afterwards, a first curing process 270 (e.g. cross-linking process) is performed to cure the intermediate solution 250a on the second surface to form a phosphor layer 250b. Finally, a wafer dicing process 280 is performed to form a plurality of light emitting diode dies 290 with a phosphor layer. In addition, the preferred design of the light emitting diode dies 290 with a phosphor layer is in a flip chip state.

In this embodiment, the thickness of the phosphor layer 250b is equal to or greater than 20 nm. The preferred thickness is equal to or greater than 1 μm (which is called “thick film phosphor layer”), and more preferred, the thickness is equal to or greater than 10 μm. The preferred shape of the phosphor layer 250b is in the form of plate. Furthermore, the preferred shape of the phosphor substance is in the form of particles. The particle diameter is equal to or greater than 10 nm. Moreover, the depositing process comprises one of the following group: coating, printing, screen printing, spraying, impressing and injet printing.

In a preferred example of this embodiment, the organic material 220 is two-component type polyimide (PI) in a two-component mixed solution state that will not polymerize under room temperature. The corresponding curing process 270 includes a softbake step and a hardbake step. After the softbake step is performed for 50 seconds at 135° C., the hardbake step is performed for 30 minutes at 400° C. The pure two-component type polyimide (without phosphor substance 230) has Tg=371° C. and Td=597° C. after curing. In another preferred embodiment of this embodiment, the organic material 220 is PEI. The preferred solvent is 1,4-dioxane. The corresponding curing process 270 is performed to remove the solvent under an environment with constant temperature and humidity (temperature lower than 50° C. and relative humidity lower than 50%). The pure PEI (without phosphor substance 230) has Tg=215° C. after curing.

In this embodiment, before the wafer dicing process 280, a protection treatment process can be performed to form a protection layer on the phosphor layer 250b to prevent the phosphor layer 250b from moisture, acid, and base exposure or external force impact so as to increase the lifetime of the phosphor substance. For instance, a protection treatment process is performed by providing and coating a protection paint on the phosphor layer 250b, and thereby performing a second curing process to cure the protection paint on the phosphor layer 250b to form a protection layer. The second curing process includes a cross-linking process. Another protection treatment process is performed before the curing process. For example, a protection sheet is provided and then pressed with the intermediate solution 250a on the second surface. The protection sheet and the intermediate solution 250a are adhered together by the subsequent curing process 270.

In this embodiment, before the wafer dicing process 280, an ultraviolet light treatment process can be performed to form an ultraviolet light blocking layer on the phosphor layer 250b. The ultraviolet light blocking layer absorbs or reflects the ultraviolet light that is not absorbed by the phosphor substance to prevent the ultraviolet light from being outbound. For example, an ultraviolet light treatment process is performed by providing an ultraviolet light blocking sheet and then pressing the ultraviolet light blocking sheet with the intermediate solution 250a on the second surface. The ultraviolet light blocking sheet and the intermediate solution 250a are adhered together by the subsequent curing process 270.

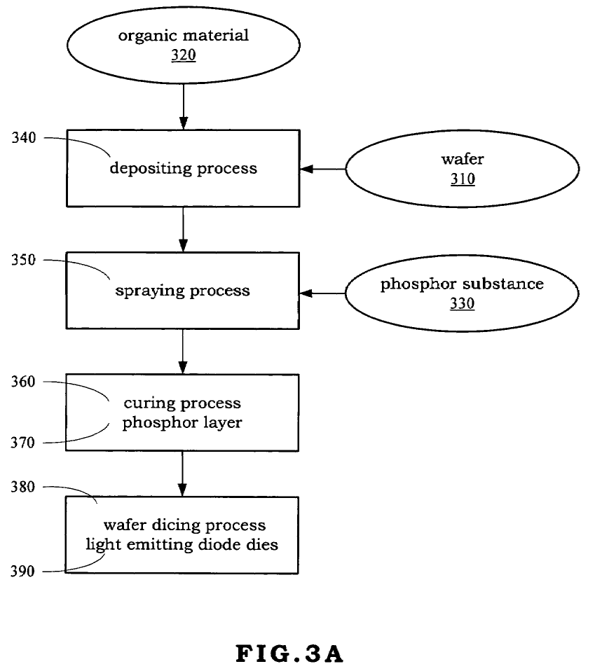

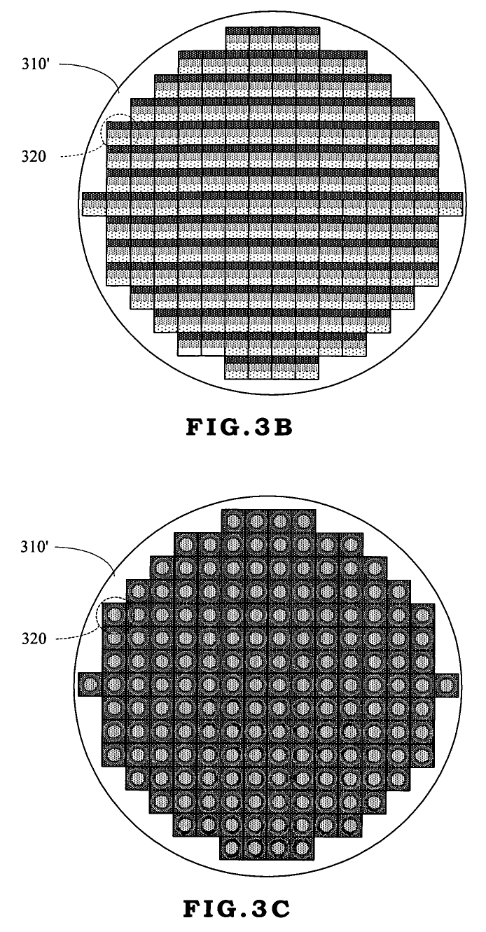

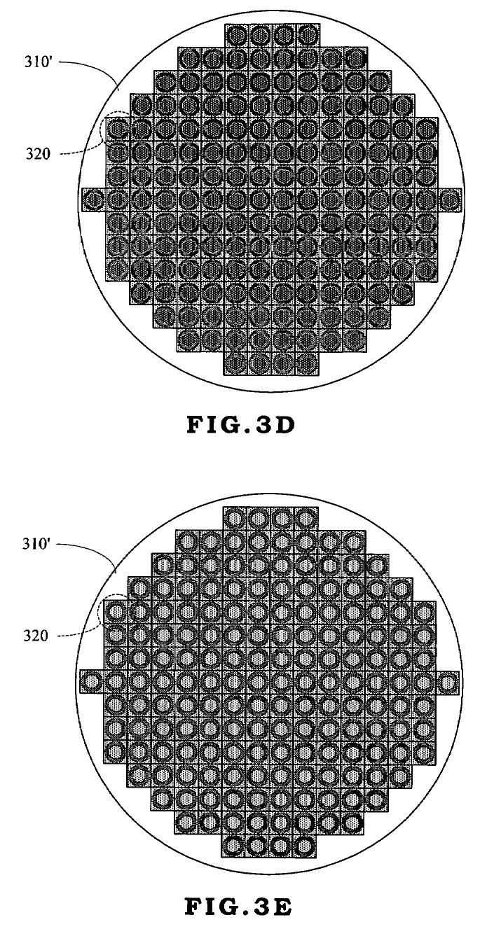

As shown in FIG. 3A, the third embodiment of the invention discloses a method for forming a light emitting diode die with at least one phosphor layer. At first, a wafer 310 having a first surface and a second surface opposing to said first surface is provided, and a light-emitting structure is then formed on said first surface of said wafer. Next, a depositing process 340 is performed to deposit at least one type of organic material 320 onto the second surface of the wafer. Subsequently, a spraying process 350 is performed to spray at least one type of phosphor substance 330 onto the organic material 320. A curing process 360 (e.g. cross-linking process) is then performed to cure the organic material 320 on the second surface to fix the relative position between the phosphor substance 330 and the organic material 320 so as to form a phosphor layer 370. Finally, a wafer dicing process 380 is performed to form a plurality of light emitting diode dies 390 with a phosphor layer. The material of the wafer, the particle diameter of the phosphor substance 330, the added amount of the phosphor substance 330, the thickness of the phosphor layer 370, the material of the organic material 320, and the method for the depositing process 350 are selected to be the same as those described in the second embodiment of the present invention.

In this embodiment, t when the phosphor substance is in the form of particles, the phosphor particles can be unevenly dispersed in the phosphor layer 370 of each predetermined die by adjusting spraying time and density. For instance, the results of the spraying process 350 are shown in FIGS. 3B to 3E in which the light portion represents low distribution density of the phosphor particles and the dark portion represents high distribution density of the phosphor particles (310′ represents the wafer and 390 represents the die).

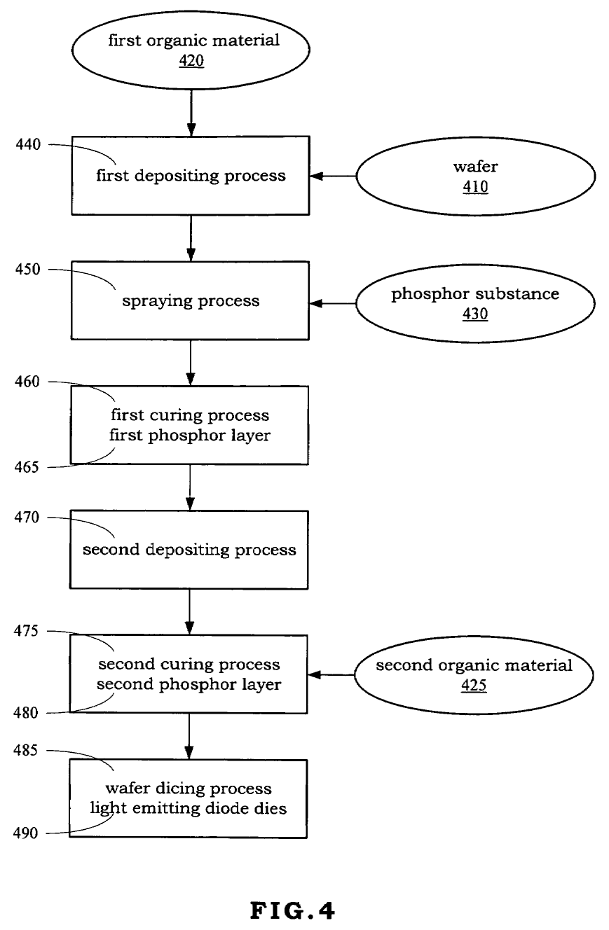

As shown in FIG. 4, the fourth embodiment of the invention discloses a method for forming a light emitting diode die with at least one phosphor layer. At first, a wafer 410 having a first surface and a second surface opposing to said first surface is provided, and a light-emitting structure is formed on said first surface of said wafer. Next, a first depositing process 440 is performed to deposit at least one type of first organic material 420 onto the second surface of the wafer. Subsequently, a spraying process 450 is performed to spray at least one type of phosphor substance 430 onto the first organic material 420. A first curing process 460 (e.g. cross-linking process) is then performed to cure the first organic material 420 on the second surface to fix the relative position between the phosphor substance 430 and the first organic material 420 so as to form a first phosphor layer 465. Afterwards, a second depositing process 470 is performed to deposit at least one type of second organic material 425 onto the phosphor layer 465. A second curing process 475 is then performed to cure the second organic material 425 on the first phosphor layer 465 to form a second phosphor layer 480. Finally, a wafer dicing process 485 is performed to form a plurality of light emitting diode dies 490 with phosphor layers. Additionally, the organic material 420 and 425 can be the same or different. Moreover, the material of the wafer, the particle diameter of the phosphor substance 430, the added amount of the phosphor substance 430, the thickness of the phosphor layer, the material of the organic material 420 and 425, the method for the depositing process, and the method for the spraying process are selected to be the same as those described in the third embodiment of the present invention.

In the embodiments, the present invention is to complete the phosphor packaging operation directly under a wafer level so as to reduce the manufacturing cost. The process according to the present invention is applicable to the diodes emitting visible and the diodes emitting non-visible light as well. In addition, according to the present invention, phosphor substance can be dispersed into organic material to form an intermediate solution and thereby the intermediate solution is deposited onto a wafer by coating, printing, screen printing, spraying, impressing and injet printing. Thus, such process is in a simple manner and easy to practice. Besides, the present invention is to disperse phosphor substance unevenly in the phosphor layer to have the dispersion density of the phosphor substance increases along at least a specific direction that parallels the direction of the phosphor layer. On the other hand, the present invention is to adjust the refractive index of each layer of the phosphor layers to have a structure with gradually changed refractive index so as to reduce the reflections of the primary light and the secondary light in the phosphor layers, which thereby increases the whole light attaining efficiency. According to the above, the present invention does have the economic advantages for industrial applications.

To sum up, the present invention discloses a light emitting diode die with at least one phosphor layer, comprising a substrate having a first surface and a second surface, a light-emitting structure formed on the first surface, and at least one phosphor layer formed on the second surface. While driven by a voltage, the light-emitting structure emits a primary light with a specific wavelength wherein the primary light is capable of transmitting through the substrate. Besides, the phosphor layer comprises at least one type of organic material and at least one type of phosphor substance that absorbs and converts part of the primary light to thereby emit at least a secondary light with a different wavelength from the specific wavelength. In addition, the present invention discloses methods for forming a light emitting diode die with at least one phosphor layer.

Many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A light emitting diode die with at least one phosphor layer, comprising:
a substrate having a first surface and a second surface opposing to said first surface;
a light-emitting structure being formed on said first surface and configured to emit a primary light with a first wavelength when driven by a voltage, wherein the substrate is configured to transmit the primary light therethrough; and,
at least one phosphor layer with a plate-shaped structure formed on said second surface, wherein said at least one phosphor layer comprises at least one type of organic material and at least one type of phosphor particles distributed in a matrix of the organic material and configured to absorb and convert at least a part of the primary light to thereby emit at least a secondary light with a different wavelength from the first wavelength.

2. The light emitting diode die according to claim 1, wherein said phosphor particles are unevenly dispersed in said phosphor layer, and the dispersion density of the phosphor particles increases along a specific direction that parallels the direction of said phosphor layer.

3. The light emitting diode die according to claim 1, wherein said phosphor particles are unevenly dispersed in said phosphor layer, and the dispersion density of the phosphor particles increases along a radial direction from the center of said phosphor layer, as viewed from top of said phosphor layer.

4. The light emitting diode die according to claim 1, wherein said phosphor particles are unevenly dispersed in said phosphor layer, and the dispersion density of the phosphor particles decreases along a radial direction from the center of said phosphor layer, as viewed from top of said phosphor layer.

5. The light emitting diode die according to claim 1, wherein said phosphor particles are unevenly dispersed in said phosphor layer, and the dispersion density of the phosphor particles has an undulating density distribution radially spreading out from the center of said phosphor layer, as viewed from top of said phosphor layer.

6. The light emitting diode die according to claim 1, wherein said organic material comprises small molecules, oligomers, or polymers.

7. The light emitting diode die according to claim 6, wherein said organic material comprises a polymer and the glass transition temperature of the polymer is equal to or greater than 150° C.

8. The light emitting diode die according to claim 6, wherein said organic material comprises a polymer and the polymer comprises epoxy, polyether-polysulfone (PES), polyarylene sulfide (PAS), polybenzimidazoles (PBI), polyacrylate, polyamide (PA), polyimide (PI), polyether-polyimide (PEI), polyarylate (PAR), cyclic olefin copolymer (COC), polycarbonate (PC), or their copolymers.

9. The light emitting diode die according to claim 6, wherein said phosphor layer is a thick film and has a thickness equal to or greater than 1 μm.

10. The light emitting diode die according to claim 1, wherein said phosphor layer is formed by a method comprising coating, printing, screen printing, spraying, impressing or inkjet printing.

11. The light emitting diode die according to claim 1, further comprising a protection layer formed on said at least one phosphor layer.

12. The light emitting diode die according to claim 1, further comprising an ultraviolet light filtering layer formed on said at least one phosphor layer to impede ultraviolet light from leaking out.

13. The light emitting diode die according to claim 12, wherein said ultraviolet light blocking layer comprises a secondary multilayer structure.

14. The light emitting diode die according to claim 13, wherein said secondary multilayer structure comprises a Bragg reflector.

15. The light emitting diode die according to claim 1, wherein said at least one phosphor layer comprises a plurality of phosphor layers.

16. The light emitting diode die according to claim 15, wherein the refractive index of each phosphor layer of said phosphor layers decreases with the increase of the distance between each phosphor layer and said light-emitting structure.

17. A method for forming a light emitting diode die with at least one phosphor layer, comprising:
providing a wafer having a first surface and a second surface opposing to said first surface;
forming a light-emitting structure on said first surface of said wafer;
blending at least one type of phosphor substance with at least one type of organic material to disperse said phosphor substance into said organic material so as to form an intermediate solution;
performing a depositing process to deposit said intermediate solution onto said second surface of said wafer;
performing a curing process to cure said intermediate solution on said second surface to form a phosphor layer; and
performing a wafer dicing process to form a plurality of light emitting diode dies with a phosphor layer.

18. The method according to claim 17, wherein said organic material comprises molecules, oligomers, or polymers.

19. The method according to claim 17, wherein said organic material is polymer and the glass transition temperature of the polymer is equal to or more than 150° C.

20. The method according to claim 17, wherein said organic material is polymer and the polymer comprises epoxy, polyether-polysulfone (PES), polyarylene sulfide (PAS), polybenzimidazoles (PBI), polyacrylate, polyamide (PA), polyimide (PI), polyether-polyimide (PEI), polyarylate (PAR), cyclic olefin copolymer (COC), polycarbonate (PC), or their copolymers.

21. The method according to claim 17, wherein said depositing process comprises coating, printing, screen printing, spraying, impressing or inkjet printing.

22. The method according to claim 17, wherein said curing process comprises a cross-linking process.

23. A method for forming a light emitting diode die with at least one phosphor layer, comprising:
providing a wafer having a first surface and a second surface opposing to said first surface;
forming a light-emitting structure on said first surface of said wafer;
performing a depositing process to deposit at least one type of organic material onto said second surface of said wafer;
performing a spraying process to spray at least one type of phosphor substance onto said organic material;
performing a curing process to cure said organic material on said second surface to fix the relative position between said phosphor substance and said organic material so as to form a phosphor layer; and
performing a wafer dicing process to form a plurality of light emitting diode dies with a phosphor layer.

24. The method according to claim 23, wherein said phosphor particles are unevenly dispersed in said phosphor layer, and the dispersion density of the phosphor particles increases along a specific direction that parallels the direction of said phosphor layer.

25. The method according to claim 23, wherein said phosphor particles are unevenly dispersed in said phosphor layer, and the dispersion density of the phosphor particles increases along a radial direction from the center of said phosphor layer, as viewed from top of said phosphor layer.

26. The method according to claim 23, wherein said phosphor particles are unevenly dispersed in said phosphor layer, and the dispersion density of the phosphor particles decreases along a radial direction from the center of said phosphor layer, as viewed from top of said phosphor layer.

27. The method according to claim 23, wherein said phosphor particles are unevenly dispersed in said phosphor layer, and the dispersion density of the phosphor particles has an undulating distribution radially spreading out from the center of said phosphor layer, as viewed from top of said phosphor layer.

28. A method for forming a light emitting diode die with at least one phosphor layer, comprising:
providing a wafer having a first surface and a second surface opposing to said first surface;
forming a light-emitting structure on said first surface of said wafer;
performing a first depositing process to deposit at least one type of first organic material onto said second surface of said wafer;
performing a spraying process to spray at least one type of phosphor substance onto said first organic material;
performing a first curing process to cure said first organic material on said second surface to fix the relative position between said phosphor substance and said first organic material so as to form a first phosphor layer;
performing a second depositing process to deposit at least one type of second organic material onto said first phosphor layer;
performing a second curing process to cure said second organic material on said first phosphor layer so as to form a second phosphor layer; and,
performing a wafer dicing process to form a plurality of light emitting diode dies with phosphor layers.

29. The method according to claim 28, wherein said phosphor particles are unevenly dispersed on said first phosphor layer, and the dispersion density of the phosphor particles increases along a specific direction that parallels the direction of said phosphor layer.

30. The method according to claim 28, wherein said phosphor particles are unevenly dispersed on said first phosphor layer, and the dispersion density of the phosphor particles increases along a radial direction from the center of said phosphor layer, as viewed from top of said phosphor layer.

31. The method according to claim 28, wherein said phosphor particles are unevenly dispersed on said first phosphor layer, and the dispersion density of the phosphor particles decreases along a radial direction from the center of said phosphor layer, as viewed from top of said phosphor layer.

32. The method according to claim 28, wherein said phosphor substance is in the form of particles and the phosphor particles are unevenly dispersed on said first phosphor layer, and the dispersion density of the phosphor particles has an undulating distribution radially spreading out from the center of said phosphor layer, as viewed from top of said phosphor layer.
